(19) United States
(12) Patent Application Publication
(10) Pub. No.: US 2019/0235305 A1
(43) Pub. Date: Aug. 1, 2019

(54) HEAD-UP DISPLAY DEVICE AND DISPLAY DEVICE

(71) Applicant: Yazaki Corporation, Tokyo (JP)

(72) Inventors: Takeyoshi Watanabe, Shizuoka (JP); Noriaki Narushima, Shizuoka (JP)

(21) Appl. No.: 16/262,867

(22) Filed: Jan. 30, 2019

(30) Foreign Application Priority Data
Feb. 1, 2018 (JP) 2018-016428

(51) Int. Cl. G02F 1/1333; G02F 1/1335; G02B 27/01; B60K 35/00

(52) U.S. Cl. CPC G02F 1/133385; G02F 1/133528; G02B 27/0101; B60K 2350/2078; B60K 35/00; B60K 2350/1072; B60K 2350/2052; G02F 1/133502

(57) ABSTRACT

A head-up display device includes: a light source; a liquid crystal display device that includes a first polarization plate, a liquid crystal display unit, and a second polarization plate, and projects light that is emitted from the light source and is transmitted through the first polarization plate, the liquid crystal display unit, and the second polarization plate; and a reflective member that reflects the light projected from the liquid crystal display device toward a reflective surface. At least one of the first polarization plate and the second polarization plate is separated from the liquid crystal display unit by an air layer.

### CROSS-REFERENCE TO RELATED APPLICATION(S)

The present application claims priority to and incorporates by reference the entire contents of Japanese Patent Application No. 2018-016428 filed in Japan on Feb. 1, 2018.

### BACKGROUND OF THE INVENTION

### 1. Field of the Invention

The present invention relates to a head-up display device and a display device.

### 2. Description of the Related Art

A head-up display device that displays a virtual image by using a reflective surface of a windshield of a vehicle is known. Japanese Patent Application Laid-open No. 2016-102871 discloses a technology related to a head-up display device in which a non-transmission state segment formed region and a background region are reflection-displayed, when external light is incident to a liquid crystal panel from a display side polarization plate side, and the external light is reflected from a reflection type polarization plate. According to the technology disclosed in Japanese Patent Application Laid-open No. 2016-102871, visibility of a display image can be secured while power consumption is suppressed.

However, when light such as external light (for example, solar light) is incident to the head-up display device, a temperature of a liquid crystal layer and the like which are provided in the head-up display device may rise.

### SUMMARY OF THE INVENTION

An object of the present invention is to provide a head-up display device and a display device which are capable of suppressing temperature rise of a liquid crystal layer.

In order to achieve the above mentioned object, a head-up display device according to one aspect of the present invention includes a light source; a liquid crystal display device that includes a first polarization plate, a liquid crystal display unit, and a second polarization plate, and projects light that is emitted from the light source and is transmitted through the first polarization plate, the liquid crystal display unit, and the second polarization plate as display light of an image; and a reflective member that reflects the light projected from the liquid crystal display device toward a reflective surface that is disposed at a position that faces an eye point of a vehicle, wherein the liquid crystal display unit includes a liquid crystal layer, a first substrate that is provided on a surface of the liquid crystal layer on the first polarization plate side and includes a first transparent electrode, and a second substrate that is provided on a surface of the liquid crystal layer on the second polarization plate side and includes a second transparent electrode, and at least one of the first polarization plate and the second polarization plate is separated from the liquid crystal display unit by an air layer.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic configuration view of a head-up display device according to an embodiment;

FIG. 2 is a schematic view of the head-up display device according to the embodiment;

FIG. 3 is a schematic view of a display device according to the embodiment;

FIG. 4 is a schematic view of a head-up display device according to a first modification example of the embodiment;

FIG. 5 is a schematic view of a head-up display device according to a second modification example of the embodiment; and

FIG. 6 is a schematic view of a head-up display device according to a third modification example of the embodiment.

### DETAILED DESCRIPTION OF THE PREFERRED EMBODIMENTS

Hereinafter, a head-up display device and a display device according to an embodiment of the present invention will be described in detail with reference to the accompanying drawings. Furthermore, the present invention is not limited to the embodiment. In addition, an element that can be easily assumed by those skilled in the art, or substantially the same element is included in constituent elements in the following embodiment.

### Embodiment

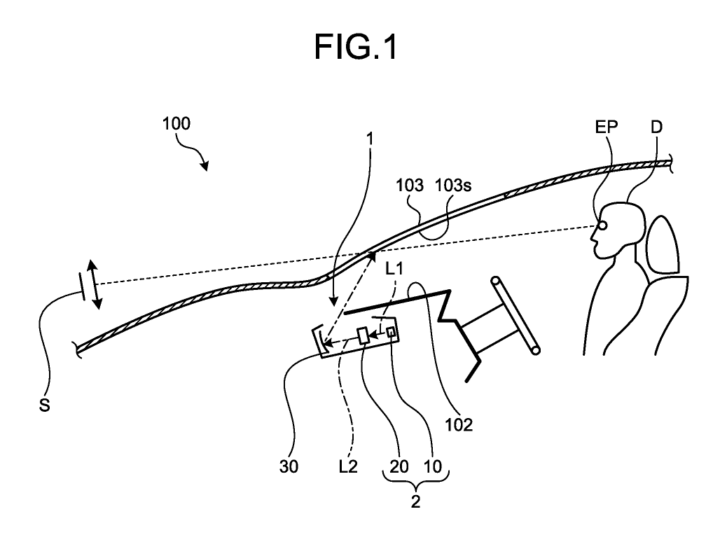

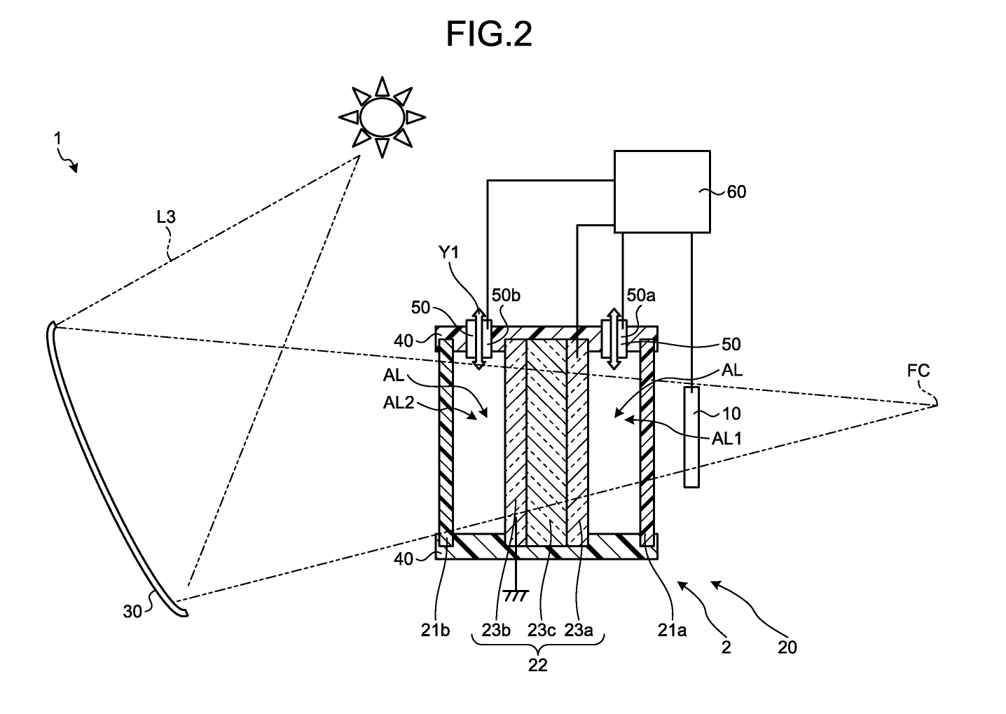

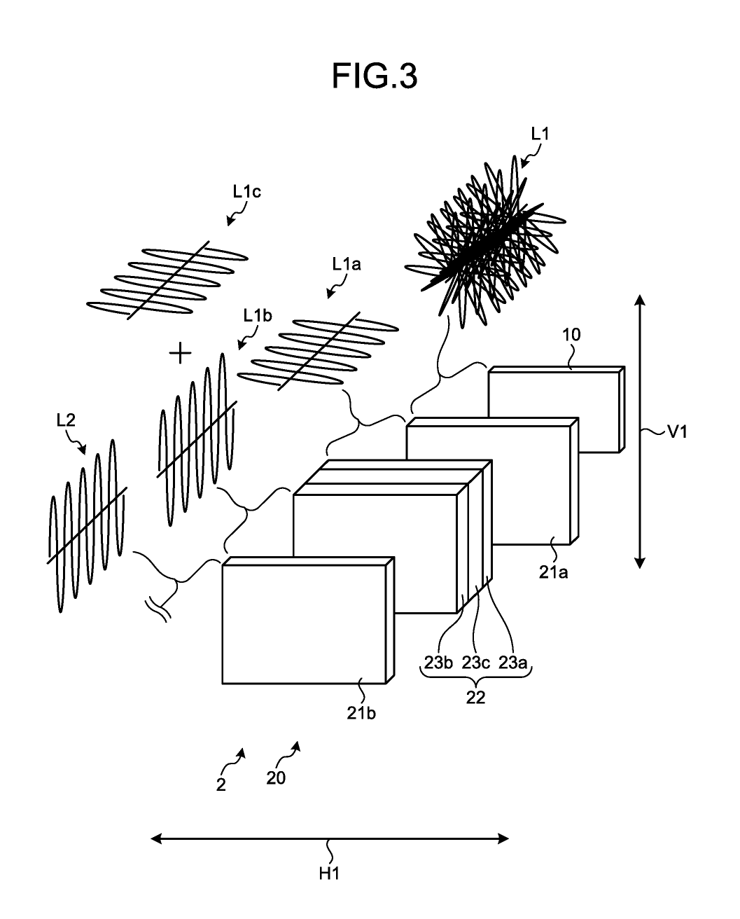

The embodiment will be described with reference to FIGS. 1 to 3. The embodiment relates to a head-up display device and a display device. FIG. 1 is a schematic configuration view of the head-up display device according to the embodiment. FIG. 2 is a schematic view of the head-up display device according to the embodiment. FIG. 3 is a schematic view of the display device according to the embodiment. Furthermore, in FIG. 2, the display device provided in the head-up display device is illustrated as a cross-sectional view. In FIG. 3, a holder in the display device is not illustrated.

A head-up display device 1 according to the embodiment is mounted on a vehicle 100 such as an automobile as illustrated in FIG. 1. The head-up display device 1 is disposed on an inner side of a dashboard 102 of the vehicle 100, and projects display light L2 to a reflective surface 103s of a display member 103 in the vehicle 100. In the embodiment, the display member 103 is a windshield. The display member 103 is disposed in front of a driver D in the vehicle 100. The reflective surface 103s of the display member 103 may be provided with a semi-transmitting coating or the like which reflects a part of incident light and transmits a part of the light therethrough. The display light L2 projected to the reflective surface 103s is reflected from the reflective surface 103s to an eye point EP of the vehicle 100, and is visually confirmed as a virtual image S by the driver D.

The head-up display device 1 according to this embodiment includes a display device 2 according to the embodiment. The head-up display device 1 includes the display device 2 and a reflective member 30. The display device 2 includes a light source 10 and a liquid crystal display device 20. The light source 10 is lighted when electric power is supplied from a power supply of the vehicle 100. As the light source 10, a light emitting diode (LED) and the like can be used. The liquid crystal display device 20 allows a part of light L1 emitted from the light source 10 to be transmitted therethrough, and projects the transmitted light L1 toward the reflective member 30 as the display light L2 of an image. The reflective member 30 reflects the light (display light L2) projected from the liquid crystal display device 20 toward the reflective surface 103s disposed at a position that faces the eye point EP of the vehicle. The display light L2 is reflected by the reflective surface 103s, and is visually confirmed as the virtual image S by the driver D. The reflective member 30 of the embodiment is an magnifying mirror that magnifies and reflects the display light L2. As the reflective member 30, for example, an aspheric mirror can be used.

As illustrated in FIG. 2, the liquid crystal display device 20 includes a first polarization plate 21a, a second polarization plate 21b, and a liquid crystal display unit 22. The liquid crystal display unit 22 is disposed between the first polarization plate 21a and the second polarization plate 21b.

As illustrated in FIG. 3, the first polarization plate 21a and the second polarization plate 21b are polarization plates having a rectangular plate shape. The first polarization plate 21a and the second polarization plate 21b are disposed in a state in which one main surface of each of them faces each other. Here, main surfaces of the first polarization plate 21a represent two planes on a rear side and on a front side except four end surfaces among peripheral six surfaces in the first polarization plate 21a. Similarly, main surfaces of the second polarization plate 21b represent two planes on a rear side and on a front side except four end surfaces among peripheral six surfaces.

The first polarization plate 21a and the second polarization plate 21b allow light that vibrates in a specific direction to be transmitted therethrough. In the first polarization plate 21a and the second polarization plate 21b, a vibration direction of the transmitting light is referred to as a transmission axis, and a direction orthogonal to the transmission axis is referred to as an absorption axis. The first polarization plate 21a and the second polarization plate 21b are prepared by stretching a transparent film to which a pigment such as iodine is added in one direction. Stretching directions at this time become the absorption axes of the first polarization plate 21a and the second polarization plate 21b.

In the embodiment, the first polarization plate 21a is disposed to allow light, which vibrates in a horizontal direction indicated by an arrow H1 in FIG. 3, to be transmitted therethrough. That is, the first polarization plate 21a sets the horizontal direction as a transmission axis direction, and allows light that vibrates in the transmission axis direction to be transmitted therethrough. On the other hand, the first polarization plate 21a substantially blocks light that vibrates in an absorption axis direction orthogonal to the transmission axis direction.

The second polarization plate 21b is disposed to have a crossed Nichol relationship with respect to the first polarization plate 21a. The second polarization plate 21b is disposed to allow light that vibrates in a vertical direction indicated by an arrow V1 in FIG. 3 to be transmitted therethrough. That is, the second polarization plate 21b sets the vertical direction as the transmission axis direction, and allows light that vibrates in the transmission axis direction to be transmitted therethrough. On the other hand, the second polarization plate 21b substantially blocks light that vibrates in the absorption axis direction orthogonal to the transmission axis direction. Furthermore, the first polarization plate 21a and the second polarization plate 21b may have a structure in which a film-shaped polarization element is stuck to a glass plate or inserted and fixed to the glass plate.

The liquid crystal display unit 22 includes a first substrate 23a including a first transparent electrode, a second substrate 23b including a second transparent electrode, and a liquid crystal layer 23c. The first substrate 23a is provided on a surface of the liquid crystal layer 23c on the first polarization plate 21a side. The second substrate 23b is provided on a surface of the liquid crystal layer 23c on the second polarization plate 21b side. For example, the first transparent electrode and the second transparent electrode are electrodes which are formed by using an indium tin oxide (ITO).

In the embodiment, the first substrate 23a and the second substrate 23b include a plate-shaped glass substrate. In the first substrate 23a, a plurality of thin film transistor elements (TFT elements), which include a plurality of the first transparent electrodes as pixel electrode, are formed on a surface of the glass substrate. Each of the TFT elements is a switch that is formed in correspondence with each of the first transparent electrodes and controls putting operation of charges (pixel signals) in the first transparent electrode.

In addition, in the second substrate 23b, a second transparent electrode as a common electrode is formed on a surface of the glass substrate. The second transparent electrode is a sheet of plate-shaped transparent electrode and is disposed to face the plurality of first transparent electrodes. The second transparent electrode is connected to a ground potential. An electric field occurs in the liquid crystal layer 23c due to a potential difference between the first transparent electrodes charged with charges, and the second transparent electrode.

Each of the first substrate 23a and the second substrate 23b includes an orientation film on a surface of the glass substrate on the liquid crystal layer 23c side. The orientation films are films which orient liquid crystal molecules from the transmission axis direction of the first polarization plate 21a to the transmission axis direction of the second polarization plate 21b. The orientation films are prepared by performing a rubbing treatment with respect to a surface of a polymer film formed by using polyimide and the like. That is, the orientation films are prepared by rubbing the surface of the polymer film with cloth in one direction. Minute strip-shaped grooves are formed in the orientation films by the rubbing treatment. At this time, a cloth-rubbing direction (rubbing direction) becomes an orientation direction of liquid crystal molecules.

The orientation films are disposed with the liquid crystal layer 23c interposed therebetween, and are in contact with the liquid crystal layer 23c. The orientation film of the first substrate 23a and the orientation film of the second substrate 23b are disposed so that rubbing directions thereof are orthogonal to each other. In the embodiment, the rubbing direction in the first substrate 23a is a direction along the horizontal direction, and the rubbing direction in the second substrate 23b is a direction along the vertical direction. In a state in which an electric field does not occur in the liquid crystal layer 23c, liquid crystal molecules of the liquid crystal layer 23c have a property of orienting in the same direction. Due to the property, an orientation direction of the liquid crystal molecules gradually varies from the rubbing direction of the orientation film in the first substrate 23a to the rubbing direction of the orientation film in the second substrate 23b. That is, a crystal orientation of the liquid crystal layer 23c enters a state of being twisted by 90° over a region ranging from the first substrate 23a side to the second substrate 23b side. Here, in a case where the first transparent electrode is charged with charges, and an electric field occurs in the liquid crystal layer 23c due to a potential difference between the second transparent electrode (common electrode) and the first transparent electrode (pixel electrode), liquid crystal molecules in the liquid crystal layer 23c are arranged in a line along a direction of the electric field (direction from the second transparent electrode to the first transparent electrode). That is, the crystal orientation of the liquid crystal layer 23c is controlled by the potential difference between the second transparent electrode and the first transparent electrode.

As illustrated in FIG. 2, the first polarization plate 21a is separated from the liquid crystal display unit 22 by an air layer AL (a first air layer AL1). In addition, the second polarization plate 21b is separated from the liquid crystal display unit 22 by an air layer AL (a second air layer AL2). That is, the first polarization plate 21a and the second polarization plate 21b are disposed to be separated from the liquid crystal display unit 22. The air layer AL is a layer that is substantially formed from air in the atmosphere.

Here, one main surface of the first polarization plate 21a is disposed to be parallel to a surface of the first substrate 23a on a side opposite to the liquid crystal layer 23c. The one main surface of the first polarization plate 21a is disposed to face the surface of the first substrate 23a on the side opposite to the liquid crystal layer 23c. When viewed from the light source 10 side, the first polarization plate 21a is disposed to overlap the entirety of the first substrate 23a. In a direction from the liquid crystal display unit 22 toward the light source 10, the first polarization plate 21a is a forefront polarization plate from the liquid crystal display unit 22 side. That is, in the embodiment, another polarization plate is not provided between the liquid crystal display unit 22 and the first polarization plate 21a.

In addition, one main surface of the second polarization plate 21b is disposed to be parallel to a surface of the second substrate 23b on a side opposite to the liquid crystal layer 23c. The one main surface of the second polarization plate 21b is disposed to face the surface of the second substrate 23b on the side opposite to the liquid crystal layer 23c. When viewed from the reflective member 30 side, the second polarization plate 21b is disposed to overlap the entirety of the second substrate 23b. In a direction from the liquid crystal display unit 22 toward the reflective member 30, the second polarization plate 21b is a forefront polarization plate from the liquid crystal display unit 22 side. That is, in the embodiment, another polarization plate is not provided between the liquid crystal display unit 22 and the second polarization plate 21b.

Here, in the liquid crystal display device 20, the first polarization plate 21a, the liquid crystal display unit 22, and the second polarization plate 21b constitute a minimum unit of a configuration of generating the display light L2 from the light L1 emitted from the light source 10.

The thickness of the first air layer AL1 (a distance between the first polarization plate 21a and the liquid crystal display unit 22) is set in consideration of the amount of heat transferred from the first polarization plate 21a to the liquid crystal display unit 22 or an influence on display quality as the liquid crystal display device 20. Similarly, the thickness of the second air layer AL2 (a distance between the second polarization plate 21b and the liquid crystal display unit 22) is set in consideration of the amount of heat transferred from the second polarization plate 21b to the liquid crystal display unit 22 or an influence on the display quality as the liquid crystal display device 20.

As illustrated in FIG. 2, a holder 40 is provided in the liquid crystal display device 20. The holder 40 fixes the first polarization plate 21a, the second polarization plate 21b, and the liquid crystal display unit 22 by surrounding side surfaces thereof. The holder 40 of the embodiment is formed from a resin material.

A fan 50 is provided in the liquid crystal display device 20. As indicated by an arrow Y1 in FIG. 2, the fan 50 replaces air of the air layer AL with outside air. The fan 50 operates when electric power is supplied from a power supply of the vehicle 100 (refer to FIG. 1). The fan 50 discharges air of the air layer AL to the outside of the liquid crystal display device 20 while feeding air from the outside of the liquid crystal display device 20. Two fans 50 (a first fan 50a and a second fan 50b) are provided in the liquid crystal display device 20. The first fan 50a replaces air of the first air layer AL1 with outside air. The second fan 50b replaces air of the second air layer AL2 with outside air. The first fan 50a and the second fan 50b are attached in the holder 40.

As illustrated in FIG. 2, a control unit 60 is provided in the head-up display device 1 of the embodiment. The control unit 60 is electrically connected to the light source 10 and the first transparent electrode. The control unit 60 controls on/off of the light source 10. In addition, the control unit 60 controls the first transparent electrode to control the crystal orientation of the liquid crystal layer 23c. In addition, in the embodiment, the control unit 60 is electrically connected to the fans 50 (the first fan 50a and the second fan 50b). The control unit 60 controls on/off of the fan 50 (the first fan 50a and the second fan 50b).

Next, a driving method of the head-up display device 1 according to the embodiment will be described. The display device 2 according to the embodiment is an active matrix driving type display device. Hereinafter, a digital type driving method will be described.

In the first substrate 23a of the liquid crystal display unit 22, when the TFT element enters an on-state in a voltage-applied state, if a current flows to the first transparent electrode, the first transparent electrode is charged with charges. When the first transparent electrode is charged with charges, an electric field occurs in the liquid crystal layer 23c. Here, the first transparent electrode functions as a so-called pixel electrode. When the TFT element enters an off-state, charges put in the first transparent electrode do not flow to the outside, and thus the charges put in the first transparent electrode are retained, and thus the electric field in the liquid crystal layer 23c is retained. Then, when the TFT element enters an on-state in a voltage-not-applied state, a current flows from the first transparent electrode, and charges put in the first transparent electrode are discharged, and thus the electric field in the liquid crystal layer 23c is released. The plurality of first transparent electrodes is arranged on the glass substrate of the first substrate 23a in a matrix shape in vertical and horizontal directions. Presence or absence of charges put in the first transparent electrodes is controlled for each of the first transparent electrodes by on/off states of the TFT element.

The liquid crystal layer 23c allows an orientation direction of liquid crystal molecules to vary in correspondence with a potential difference between the first transparent electrode and the second transparent electrode. In a state in which a potential difference does not occur between the first transparent electrode and the second transparent electrode, the liquid crystal display device 20 enters a transmission state (display state) in which the light L1 emitted from the light source 10 is allowed to be transmitted therethrough. On the other hand, in a state in which a potential difference occurs between the first transparent electrode and the second transparent electrode, the liquid crystal display device 20 enters a non-transmission state (non-display state) in which the light L1 emitted from the light source 10 is not substantially allowed to be transmitted therethrough.

In the embodiment, the crystal orientation of the liquid crystal layer 23c is controlled for each region (active region) in the liquid crystal layer 23c corresponding to one of the first transparent electrodes. That is, the transmission state and the non-transmission state in the liquid crystal display device 20 are controlled for each active region. An image pattern is formed by this control.

As illustrated in FIG. 3, the liquid crystal display device 20 has a configuration in which light that is emitted from the light source 10 and is transmitted through the first polarization plate 21a, the liquid crystal display unit 22, and the second polarization plate 21b is projected as the display light L2. First, the light L1 that is emitted from the light source 10 toward the first polarization plate 21a is polarized by the first polarization plate 21a. The first polarization plate 21a allows light vibrating in the transmission axis direction of the first polarization plate 21a to be transmitted therethrough toward the liquid crystal display unit 22 as first polarized light L1a, and substantially blocks light that vibrates in the absorption axis direction of the first polarization plate 21a.

Then, the first polarized light L1a is incident to the liquid crystal display unit 22. In the liquid crystal display unit 22, the first polarized light L1a that is incident to a transmission-state active region rotates in an optical axis direction by 90° within the liquid crystal layer 23c. The light that has rotated within the liquid crystal layer 23c is emitted from the liquid crystal display unit 22 toward the second polarization plate 21b as first liquid crystal transmitting light Lib. On the other hand, in the liquid crystal display unit 22, the first polarized light L1a that is incident to a non-transmission-state active region is emitted from the liquid crystal display unit 22 as second liquid crystal transmitting light L1c without changing an optical vibration direction within the liquid crystal layer 23c.

The first liquid crystal transmitting light Lib emitted from the liquid crystal display unit 22 becomes light that vibrates in the transmission axis direction of the second polarization plate 21b. On the other hand, the second liquid crystal transmitting light L1c is in a state of light that vibrates in the absorption axis direction of the second polarization plate 21b. Accordingly, the first liquid crystal transmitting light Lib is transmitted through the second polarization plate 21b, and the second liquid crystal transmitting light L1c is substantially blocked by the second polarization plate 21b.

The light transmitted through the second polarization plate 21b is projected toward the reflective member 30 as the display light L2 as illustrated in FIG. 1. The reflective member 30 reflects the display light L2 toward the reflective surface 103s of the display member 103. The light reflected toward the reflective surface 103s is reflected by the reflective surface 103s toward the eye point EP of the vehicle 100. In a case where the driver D gets on the vehicle 100, the display light L2 reflected by the reflective surface 103s is visually confirmed as a virtual image S by the driver D. As described above, the virtual image S is projected by the head-up display device 1.

Furthermore, in digital-type driving in the head-up display device 1, luminance expression in an image pattern becomes possible by controlling a transmission area or a transmission time of light in the liquid crystal display device 20.

Furthermore, the head-up display device 1 of the embodiment may be driven in an analogue type. In the display device 2, the liquid crystal display device 20 can enter a semi-transmission state by controlling a potential difference between the first transparent electrode and the second transparent electrode to a value between the potential difference in the transmission state and the potential difference in the non-transmission state. Here, the semi-transmission state represents a state in which a part of the light L1 emitted from the light source 10 is allowed to be transmitted through one active region. In the analogue type, the active region is controlled to any one of the transmission state, the semi-transmission state, and the non-transmission state. The luminance expression in the image pattern becomes possible by controlling the transmission state, the semi-transmission state, and the non-transmission state for each active region.

As illustrated in FIG. 2, in the head-up display device 1 according to the embodiment, external light L3 may be incident to the liquid crystal display device 20 through the reflective member 30. For example, the external light L3 is solar light. In a case where the reflective member 30 is, for example, an magnifying mirror, the external light L3 is condensed toward the liquid crystal display device 20 by the reflective member 30. In the embodiment, the reflective member 30 has a focal point FC on a side opposite to the reflective member 30 in the liquid crystal display device 20. The external light L3 is condensed toward the focal point FC by the reflective member 30. The second polarization plate 21b of the embodiment is separated from the liquid crystal display unit 22 by the second air layer AL2. In this configuration, the second polarization plate 21b is disposed at a position that is further away from the focal point FC as compared to a configuration in which the second polarization plate 21b is in contact with the liquid crystal display unit 22 (the second substrate 23b). Since the second polarization plate 21b is disposed at a position that is far away from the focal point FC, an influence of the external light L3 per area on the second polarization plate 21b is reduced. In addition, according to the configuration, heat transfer from the second polarization plate 21b heated by the external light L3 to the liquid crystal display unit 22 is reduced. Particularly, direct heat transfer from the second polarization plate 21b to the liquid crystal display unit 22 becomes indirect heat transfer through the second air layer AL2, and thus heat transfer from the second polarization plate 21b to the liquid crystal display unit 22 is reduced. In addition, the second polarization plate 21b and the liquid crystal display unit 22 are separated from each other by the second air layer AL2, and thus a thermal influence of radiant heat of the second polarization plate 21b on the liquid crystal display unit 22 is reduced.

In addition, a temperature of the liquid crystal display device 20 may rise due to light of the light source 10 in accordance with intensity of light emitted from the light source 10. In the embodiment, the first polarization plate 21a is separated from the liquid crystal display unit 22 by the first air layer AL1. According to this configuration, heat transfer from the first polarization plate 21a heated by the light emitted from the light source 10 to the liquid crystal display unit 22 is reduced. Particularly, direct heat transfer from the first polarization plate 21a to the liquid crystal display unit 22 becomes indirect heat transfer through the first air layer AL1, and thus heat transfer from the first polarization plate 21a to the liquid crystal display unit 22 is reduced. In addition, the first polarization plate 21a and the liquid crystal display unit 22 are separated from each other with a constant interval by the first air layer AL1. Accordingly, a thermal influence of radiant heat of the first polarization plate 21a on the liquid crystal display unit 22 is also reduced.

In addition, to reduce the thermal influence of the external light L3 on the liquid crystal display unit, a configuration in which a cold mirror is provided between the reflective member and the reflective surface is also considered. The cold mirror is a mirror that is subjected to an optical treatment for allowing an infrared ray to be transmitted therethrough and for reflecting visible light. Display light that is reflected from the reflective member is reflected to the reflective surface through the cold mirror. On the other hand, the infrared ray that becomes a heat source is transmitted through the cold mirror and does not reach the liquid crystal display unit through the reflective member. According to this configuration, it is possible to reduce a thermal influence of the external light L3 on the liquid crystal display unit. However, when the cold mirror is provided, the cost may increase. In the configuration of the embodiment, since the thermal influence of the external light L3 on the liquid crystal display unit 22 can be reduced even though the cold mirror is not provided, it is possible to reduce the cost.

As described above, the configuration of the head-up display device 1 according to the embodiment is a configuration capable of reducing the thermal influence of the external light L3 and the light emitted from the light source 10 on the liquid crystal display unit 22.

Furthermore, in the embodiment, description has been given on the assumption that the liquid crystal display device 20 is an active matrix driving type liquid crystal display device. However, the liquid crystal display device 20 may be a liquid crystal display device of another driving type. For example, the liquid crystal display device 20 may be a simple matrix driving type liquid crystal display device.

Furthermore, in the embodiment, description has been given on the assumption that the holder 40 is a member formed from a resin. However, the holder 40 may be formed from a metallic material. For example, when the holder 40 formed from a metal such as aluminum is used, heat dissipation of the liquid crystal display device 20 can be improved.

Furthermore, in the embodiment, description has been given of a configuration in which air of the first air layer AL1 and the second air layer AL2 is replaced with outside air by using the two fans 50 (the first fan 50a and the second fan 50b). However, there is no limitation to the configuration. For example, a blowing hole may be formed in the holder 40 instead of providing the fans 50, and replacement between air of the air layer AL and outside air may be performed through the blowing hole. In addition, the blowing hole may be formed in the holder 40, and air of the first air layer AL1 and the second air layer AL2 may be replaced with outside air by one fan 50 that is disposed on an outer side of the holder 40.

### First Modification Example of Embodiment

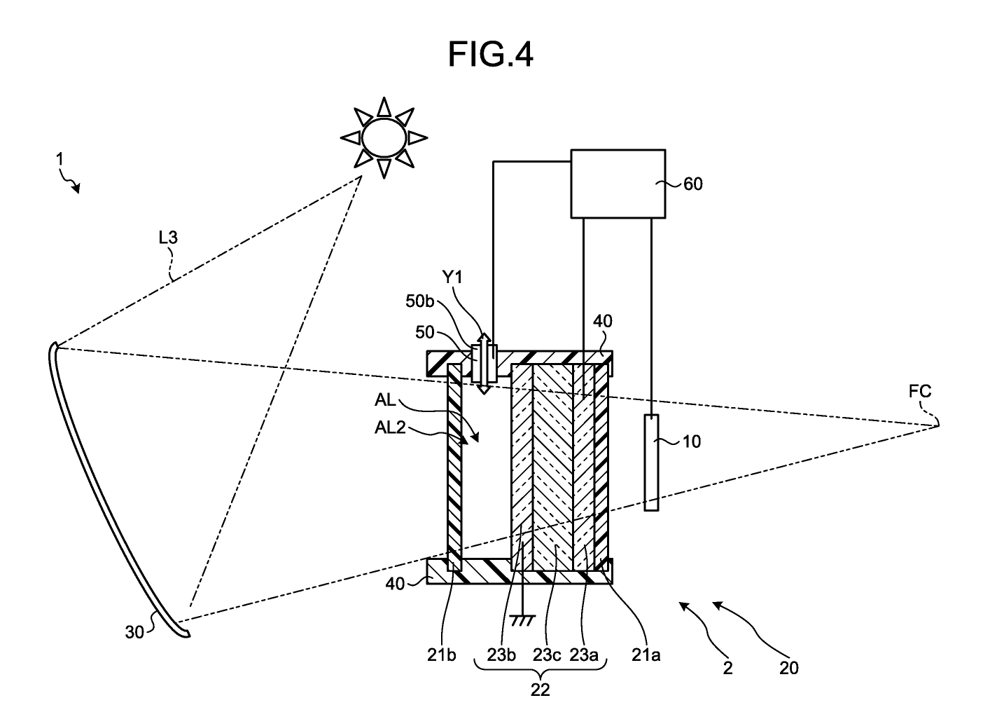

A first modification example of the embodiment will be described. This modification example relates to a head-up display device and a display device. FIG. 4 is a schematic view of the head-up display device according to the first modification example of the embodiment. FIG. 4 corresponds to FIG. 2 in the above-described embodiment.

As illustrated in FIG. 4, for example, a head-up display device 1 according to this modification example is different from the head-up display device 1 of the above-described embodiment in that the first polarization plate 21a and the first substrate 23a are in contact with each other in the liquid crystal display device 20. That is, the first air layer AL1 does not exist between the first polarization plate 21a and the first substrate 23a. In addition, a configuration in which the first fan 50a is not provided is also different from the configuration of the above-described embodiment. In addition, with regard to a display device 2 according to this modification example, for example, a difference from the above-described embodiment is in that the liquid crystal display device 20 of this modification example is provided instead of the liquid crystal display device 20 of the above-described embodiment.

The configuration of the head-up display device 1 according to this modification example, and the configuration of the display device 2 according to this modification example can be used, for example, to reduce a thermal influence of the external light L3 on the liquid crystal display unit 22.

### Second Modification Example of Embodiment

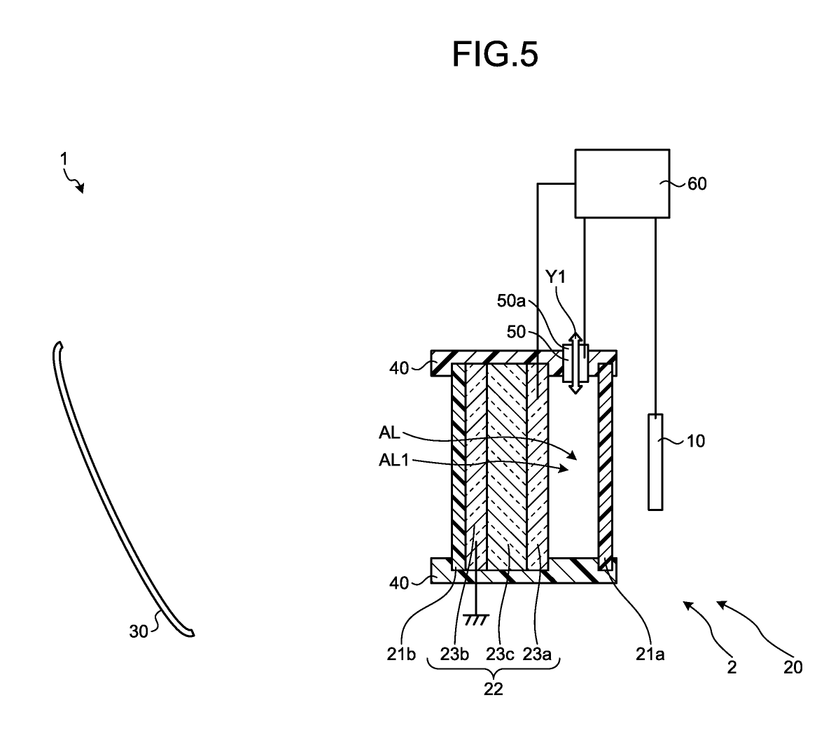

A second modification example of the embodiment will be described. This modification example relates to a head-up display device and a display device. FIG. 5 is a schematic view of the head-up display device according to the second modification example of the embodiment. FIG. 5 corresponds to FIG. 2 in the above-described embodiment.

As illustrated in FIG. 5, for example, a head-up display device 1 according to this modification example is different from the head-up display device 1 of the above-described embodiment in that the second polarization plate 21b and the second substrate 23b are in contact with each other in the liquid crystal display device 20. That is, the second air layer AL2 does not exist between the second polarization plate 21b and the second substrate 23b. In addition, a configuration in which the second fan 50b is not provided is also different from the configuration of the above-described embodiment. In addition, with regard to a display device 2 according to this modification example, for example, a difference from the above-described embodiment is in that the liquid crystal display device 20 of this modification example is provided instead of the liquid crystal display device 20 of the above-described embodiment.

The configuration of the head-up display device 1 according to this modification example, and the configuration of the display device 2 according to this modification example can be used, for example, to reduce a thermal influence of the light emitted from the light source 10 on the liquid crystal display unit 22.

### Third Modification Example of Embodiment

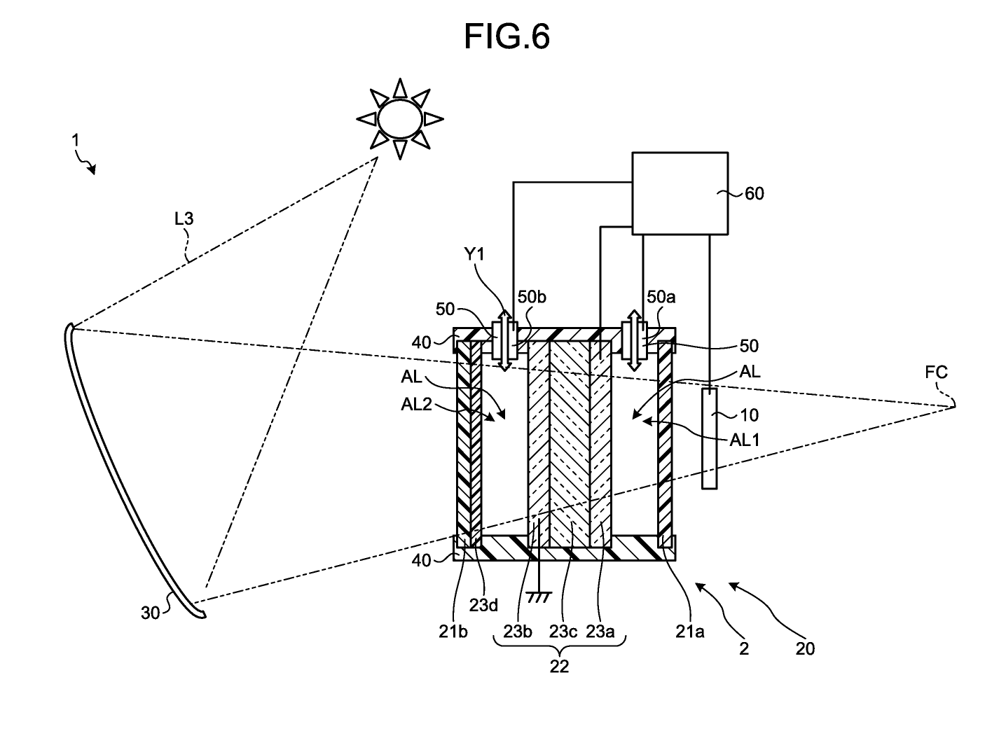

A third modification example of the embodiment will be described. This modification example relates to a head-up display device and a display device. FIG. 6 is a schematic view of the head-up display device according to the third modification example of the embodiment. FIG. 6 corresponds to FIG. 2 in the above-described embodiment.

As illustrated in FIG. 6, for example, a head-up display device 1 according to this modification example is different from the head-up display device 1 of the above-described embodiment in that the liquid crystal display device 20 includes a reflection preventing layer 23d between the second polarization plate 21b and the second substrate 23b. In addition, with regard to a display device 2 according to this modification example, for example, a difference from the above-described embodiment is in that the liquid crystal display device 20 of this modification example is provided instead of the liquid crystal display device 20 of the above-described embodiment.

The reflection preventing layer 23d reduces optical reflection between the second polarization plate 21b and the second substrate 23b. In this modification example, the reflection preventing layer 23d is a reflection preventing film that is stuck to a surface of the second polarization plate 21b on the second substrate 23b side. Furthermore, the reflection preventing layer 23d may be a layer that is formed by reflection preventing coating on the surface of the second polarization plate 21b on the second substrate 23b side. Furthermore, the reflection preventing layer 23d may be provided on a surface of the second substrate 23b on the second polarization plate 21b side. In addition, the reflection preventing layer 23d may be provided between the second polarization plate 21b and the second substrate 23b as an independent member, and may be supported by the holder 40.

### Effects of Embodiment and Respective Modification Examples

As described above, the head-up display devices 1 according to the embodiment and the modification examples include the light source 10, the liquid crystal display device 20 that includes the first polarization plate 21a, the liquid crystal display unit 22, and the second polarization plate 21b, and projects light that is emitted from the light source 10 and is transmitted through the first polarization plate 21a, the liquid crystal display unit 22, and the second polarization plate 21b as the display light L2 of an image, and the reflective member 30 that reflects the light that is projected from the liquid crystal display device 20 toward the reflective surface 103s that is disposed at a position that faces the eye point EP of the vehicle 100. The liquid crystal display unit 22 includes the liquid crystal layer 23c, the first substrate 23a that is provided on a surface of the liquid crystal layer 23c on the first polarization plate 21a side and includes the first transparent electrode, and the second substrate 23b that is provided on a surface of the liquid crystal layer 23c on the second polarization plate 21b side and includes the second transparent electrode. At least one of the first polarization plate 21a and the second polarization plate 21b is separated from the liquid crystal display unit 22 by the air layer AL.

In the head-up display devices 1 according to the embodiment and the modification examples, at least one of the first polarization plate 21a and the second polarization plate 21b is separated from the liquid crystal display unit 22 by the air layer AL. It is possible to reduce heat transfer from at least one of the first polarization plate 21a and the second polarization plate 21b to the liquid crystal display unit 22 including the liquid crystal layer 23c. Accordingly, it is possible to suppress temperature rise in the liquid crystal layer 23c.

In the head-up display devices 1 according to the embodiment, the first modification example, and the third modification example, the second polarization plate 21b and the liquid crystal display unit 22 are separated from each other by the air layer AL (the second air layer AL2). According to this configuration, it is possible to reduce a thermal influence of the external light L3 such as solar light on the liquid crystal display unit 22.

In the head-up display devices 1 according to the embodiment and the second modification example, the first polarization plate 21a and the liquid crystal display unit 22 are separated from each other by the air layer AL (the first air layer AL1). According to this configuration, it is possible to reduce a thermal influence of the light L1 emitted from the light source 10 on the liquid crystal display unit 22.

In addition, in the head-up display devices 1 according to the embodiment and the modification examples, the liquid crystal display device 20 includes the fan 50 that replaces air of the air layer AL with outside air.

Since the air of the air layer AL can be replaced with outside air by the fan 50, it is possible to reduce heat transfer from a polarization plate (for example, the first polarization plate 21a in the embodiment) to the liquid crystal display unit 22. In addition, since air of the air layer AL warmed by heat transfer from the polarization plate (for example, the first polarization plate 21a in the embodiment) is replaced with outside air, it is possible to cool down the liquid crystal display device 20.

In addition, in the head-up display device 1 according to the third modification example, the liquid crystal display device 20 includes the reflection preventing layer 23d between the second polarization plate 21b and the second substrate 23b, and the reflection preventing layer 23d reduces optical reflection between the second polarization plate 21b and the second substrate 23b.

The optical reflection between the second polarization plate 21b and the second substrate 23b is reduced by the reflection preventing layer 23d, and thus it is possible to improve display quality of the liquid crystal display device 20.

In addition, in the head-up display devices 1 according to the embodiment and the modification examples, the reflective member 30 is an magnifying mirror that magnifies and reflects the display light L2.

When the magnifying mirror is used as the reflective member 30, it is possible to magnify the display light L2 projected by the liquid crystal display device 20 and reflect the magnified display light L2 toward the reflective surface 103s. Accordingly, it is possible to project the virtual image S to a wider region when viewed form the eye point EP.

The display devices 2 according to the embodiment and the modification example include the light source 10, and the liquid crystal display device 20 that includes the first polarization plate 21a, the liquid crystal display unit 22, and the second polarization plate 21b, and projects light that is emitted from the light source 10 and is transmitted through the first polarization plate 21a, the liquid crystal display unit 22, and the second polarization plate 21b as the display light L2 of an image. The liquid crystal display unit 22 includes the liquid crystal layer 23c, the first substrate 23a that is provided on a surface of the liquid crystal layer 23c on the first polarization plate 21a side and includes the first transparent electrode, and the second substrate 23b that is provided on a surface of the liquid crystal layer 23c on the second polarization plate 21b side and includes the second transparent electrode. At least one of the first polarization plate 21a and the second polarization plate 21b is separated from the liquid crystal display unit 22 by the air layer AL.

In the display devices 2 according to the embodiment and the modification examples, at least one of the first polarization plate 21a and the second polarization plate 21b is separated from the liquid crystal display unit 22 by the air layer AL. It is possible to reduce heat transfer from at least one of the first polarization plate 21a and the second polarization plate 21b to the liquid crystal display unit 22 including the liquid crystal layer 23c. Accordingly, it is possible to suppress temperature rise in the liquid crystal layer 23c.

In the display devices 2 according to the embodiment, the first modification example, and the third modification example, the second polarization plate 21b and the liquid crystal display unit 22 are separated from each other by the air layer AL (the second air layer AL2). According to this configuration, it is possible to reduce a thermal influence of the external light L3 such as solar light on the liquid crystal display unit 22.

In the display devices 2 according to the embodiment and the second modification example, the first polarization plate 21a and the liquid crystal display unit 22 are separated from each other by the air layer AL (the first air layer AL1). According to this configuration, it is possible to reduce a thermal influence of the light L1 emitted from the light source 10 on the liquid crystal display unit 22.

The contents disclosed in the embodiment and the modification examples can be executed in an appropriate combination.

In the head-up display device according to the present embodiment, at least one of the first polarization plate and the second polarization plate is separated from the liquid crystal display unit by an air layer. According to the head-up display device according to the present invention, it is possible to reduce heat transfer to the liquid crystal display unit including the liquid crystal layer from at least one of the first polarization plate and the second polarization plate. Accordingly, it is possible to obtain an effect capable of suppressing temperature rise of the liquid crystal layer.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A head-up display device, comprising:
a light source;
a liquid crystal display device that includes a first polarization plate, a liquid crystal display unit, and a second polarization plate, and projects light that is emitted from the light source and is transmitted through the first polarization plate, the liquid crystal display unit, and the second polarization plate as display light of an image; and
a reflective member that reflects the light projected from the liquid crystal display device toward a reflective surface that is disposed at a position that faces an eye point of a vehicle, wherein
the liquid crystal display unit includes a liquid crystal layer, a first substrate that is provided on a surface of the liquid crystal layer on the first polarization plate side and includes a first transparent electrode, and a second substrate that is provided on a surface of the liquid crystal layer on the second polarization plate side and includes a second transparent electrode, and
at least one of the first polarization plate and the second polarization plate is separated from the liquid crystal display unit by an air layer.

2. The head-up display device according to claim 1, wherein
the liquid crystal display device includes a fan that replaces air of the air layer with outside air.

3. The head-up display device according to claim 1, wherein
the liquid crystal display device includes a reflection preventing layer between the second polarization plate and the second substrate, and
the reflection preventing layer reduces optical reflection between the second polarization plate and the second substrate.

4. The head-up display device according to claim 2, wherein
the liquid crystal display device includes a reflection preventing layer between the second polarization plate and the second substrate, and
the reflection preventing layer reduces optical reflection between the second polarization plate and the second substrate.

5. The head-up display device according to claim 1, wherein
the reflective member is an magnifying mirror that magnifies and reflects the display light.

6. The head-up display device according to claim 2, wherein
the reflective member is an magnifying mirror that magnifies and reflects the display light.

7. The head-up display device according to claim 3, wherein
the reflective member is an magnifying mirror that magnifies and reflects the display light.

8. The head-up display device according to claim 4, wherein
the reflective member is an magnifying mirror that magnifies and reflects the display light.

9. A display device, comprising:
a light source; and
a liquid crystal display device that includes a first polarization plate, a liquid crystal display unit, and a second polarization plate, and projects light that is emitted from the light source and is transmitted through the first polarization plate, the liquid crystal display unit, and the second polarization plate as display light of an image, wherein
the liquid crystal display unit includes a liquid crystal layer, a first substrate that is provided on a surface of the liquid crystal layer on the first polarization plate side and includes a first transparent electrode, and a second substrate that is provided on a surface of the liquid crystal layer on the second polarization plate side and includes a second transparent electrode, and
at least one of the first polarization plate and the second polarization plate is separated from the liquid crystal display unit by an air layer.
